(19) United States
(12) Patent Application Publication
(10) Pub. No.: US 2021/0360663 A1
(43) Pub. Date: Nov. 18, 2021

(54) METHOD AND APPARATUS FOR CHANNEL RESOURCE DETERMINING AND RESOURCE MAPPING

(71) Applicant: China Academy of Telecommunications Technology, Beijing (CN)

(72) Inventors: Lei WANG, Beijing (CN); Xueming PAN, Beijing (CN)

(73) Assignee: China Academy of Telecommunications Technology, Beijing (CN)

(21) Appl. No.: 16/324,124

(22) PCT Filed: Jul. 17, 2017
(86) PCT No.: PCT/CN2017/093182

§ 371 Date: Feb. 8, 2019

(30) Foreign Application Priority Data
Aug. 9, 2016 (CN) 201610649138.3

(51) Int. Cl. H04W 72/12; H04W 72/04

(52) U.S. Cl. CPC H04W 72/1273; H04W 72/0453; H04W 72/0446

(57) ABSTRACT

Disclosed are a method and apparatus for channel resource determining and resource mapping, used for enabling a user equipment to be able to determine a resource position used by a control channel of the user equipment in a resource set used by a control region of a short TTI. The method for channel resource determining provided in the present application comprises: a user equipment determining a resource set used by a control region of a short transmission time interval; and the user equipment determining a resource position used by a control channel of the user equipment in the resource set.

This application claims priority to Chinese Patent Application No. 201610649138.3, filed with the Chinese Patent Office on Aug. 9, 2016, and entitled “Method and apparatus for determining channel resource, and method and apparatus for mapping to resource”, which is hereby incorporated by reference in its entirety.

### FIELD

The present invention relates to the field of communications, and particularly to a method and apparatus for determining a channel resource, and a method and apparatus for mapping to a resource.

### BACKGROUND

With the development of the mobile technologies, future mobile communication systems need to provide a shorter network delay, and support a more diversity of service types. A short Transmission Time Interval (TTI) tends not to occupy the entire system bandwidth in the frequency domain, so a control region thereof can only be limited to some sub-band in the system bandwidth. The short TTI refers to a transmission time interval of less than 1 ms. However there has been absent so far a solution of how to determine a transmission bandwidth of a control channel with a short TTI.

The mobile Internet is toppling over the legacy mobile communication service mode, providing its subscribers with an unprecedented user experience, and profoundly affecting numerous aspects of our working and living. The mobile Internet will promote further upgrading of information exchanging modes in our society, and provide the subscribers with a more diversity of service experiences including augmented reality, virtual reality, ultra-high-definition (3D) videos, a mobile cloud, etc. Further development of the mobile Internet will bring future mobile traffic expected to grow by a factor of more than a thousand, and promote a new revolution of the mobile communication technologies and industries. The Internet of Things extends a service range of mobile communication from human-to-human communication to intelligent human-to-thing and thing-to-thing interconnectivity so that the mobile communication technologies are pervading more industries and fields. In future, mobile medical care, the Internet of Vehicles, intelligent home appliances, industry control, environmental monitoring, etc., will promote explosive growing of applications over the Internet of Things, and hundreds of billions of devices will access the network so that “all the things will be interconnected” indeed. A vast number of devices to be connected, and a diversity of services over the Internet of Things will also bring a new technical challenge to mobile communication.

As more and more new service demands are emerging constantly, a higher performance demand, e.g., a higher peak rate, a higher user experience rate, a shorter delay, high reliability, high spectrum efficiency, high energy consumption efficiency, etc., is proposed for the future mobile communication systems, and it is desirable to support a larger number of accessing subscribers, and to offer various service types. In order to support a vast number of terminals to be connected, and different service types, a flexible configuration of uplink and downlink resources is expected to be a great technological development trend. Future system resources can be divided into different sub-bands according to different services, and the sub-bands can be divided into TTIs with different lengths to satisfy various service demands.

The Frame Structure Type 1 (FS1) is applicable to the existing Long Term Evolution (LTE) Frequency Division Duplex (FDD) system, and FIG. 1 illustrates a structural diagram thereof In the FDD system, there are different carrier frequencies for uplink and downlink transmission, and the same frame structure for uplink and downlink transmission. On each carrier, a radio frame with the length of 10 ms includes ten 1 ms sub-frames, and each sub-frame includes two timeslots with the length of 0.5 ms. The time length of a TTI in uplink and downlink data transmission is 1 ms.

The Frame Structure Type 2 (FS2) as illustrated in FIG. 2 is applicable to the existing LTE Time Division Duplex (TDD) system. In the TDD system, there are different sub-frames or different timeslots, on the same frequency, for uplink and downlink transmission. In the FS2. each 10 ms radio frame includes two 5 ms half-frames, and each half-frame includes five sub-frames with the length of 1 ms. The sub-frames in the FS2 are categorized into three categories: downlink sub-frames, uplink sub-frames, and special sub-frames. Each special sub-frame includes three components, i.e., a Downlink Pilot Time Slot (DwPTS), a Guard Period (GP), and an Uplink Pilot Time Slot (UpPTS), where a downlink pilot, downlink service data, and downlink control signaling can be transmitted in the DwPTS; no signal is transmitted in the GP; and only a random access and a Sounding Reference Symbol (SRS), but neither uplink service data nor uplink control information can be transmitted in the UpPTS. Each half-frame includes at least one downlink sub-frame, at least one uplink sub-frame, and at most one special sub-frame. Table 1 depicts seven uplink-downlink sub-frame configuration modes supported in the FS2.

TABLE 1
Uplink-downlink sub-frame configurations

| Uplink- | Downlink- | | | | | | | | | | | |
|---|---|---|---|---|---|---|---|---|---|---|---|---|
| downlink | to-Uplink | | | | | | | | | | | |
| configura- | Switch-point | | Sub-frame number | | | | | | | | | |
| tion | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In the LTE system, referring to FIG. 3, the smallest resource granularity in the time domain is an Orthogonal Frequency Division Multiplex (OFDM) symbol, and the smallest resource granularity in the frequency domain is a sub-carrier. (k,l) is the index of a Resource Element (RE), where k=0, . . . , N_{RB}^{DL}N_{sc}^{RB}−1, and l=0, . . . , N_{symb}^{DL}−1. A Physical Resource Block (PB) is a resource element in a higher dimension, which includes N_{symb}^{DL}×N_{sc}^{RB} REs. There is a PRB pair in a sub-frame, and the PRB pair is an elementary unit for allocating a data resource.

Scheduling information and other control information is carried on a Physical Downlink Control Channel (PDCCH) in the LTE system. A control region of each downlink sub-frame can include a plurality of PDCCHs, and the size of the control region is determined by a Physical Control Format Indicator Channel (PCFICH) using one to four OFDM symbols. A control channel is transmitted in a Control Channel Element (CCE) or a plurality of consecutive CCEs, each CCE includes nine Resource Element Groups (REGs), and REGs in a CCE of a PDCCH are REGs on which neither a PCFICH nor a Physical Hybrid RQ Indicator Channel (PUCH) is carried. A PDCCH supports a number of formats to satisfy different demands.

In order to extend a capacity of PDCCHs, an Enhanced Physical Downlink Control Channel (EPDCCH) is introduced to the release 11 (Rel-11). EPDCCHs are transmitted in a data region of a sub-frame instead of a transmission space of PDCCHs. Like a PDCCH, the concepts of an Enhanced Resource Element Group (EREG) and an Enhanced Control Channel Element (ECCE) are further introduced in the prior art.

A set of aggregation levels supported by an EPDCCH set has been defined in the existing standard dependent upon the type of the EPDCCH set, a sub-frame type, the number of REs, for transmitting an EPDCCH, in a PRB pair, etc.

In the existing LTE system, the length of a TTI is fixed at lms, one or more PDCCHs or EPDCCHs are transmitted in the first N OFDM symbols of each TTI, or a group of PRB pairs in a data region, and a User Equipment (UE) detects blindly a Common Search Space (CSS) or a UE-specific Search Space (USS) for its PDCCH or EPDCCH according to desirable information. For the PDCCHs, their resources are distributed throughout a system bandwidth. When frequency resources in a short TTI are only a subset of the system bandwidth, a control channel of the short TTI, designed for a PDCCH, can not be mapped to any resource if the bandwidth of the short TTI is not determined.

In summary, there has been absent so far in the prior art a solution to mapping to a resource in a short TTI, and determining a corresponding channel resource.

### SUMMARY

Embodiments of the invention provide a method and apparatus for determining a channel resource, and a method and apparatus for mapping to a resource, so that a user equipment can determine the resource position for a control channel of the user equipment in a bandwidth of a control region of a short TTI.

An embodiment of the invention provides a method for determining a channel resource. The method includes:

determining, by a user equipment, a resource set for a control region of a short Transmission Time Interval (TTI); and

determining, by the user equipment, a set of resources for a control channel of the user equipment in the resource set.

With this method, the user equipment determines the resource set for the control region of the short TTI, and determines the set of resources for the control channel of the user equipment in the resource set, so that the user equipment can determine the resources for the control channel of the user equipment in the resource set for the control region of the short TTI.

Optionally determining, by the user equipment, the resource set for the control region of the short TTI includes:

obtaining, by the user equipment, the resource set for the control region of the short TTI through higher-layer signaling; or

obtaining, by the user equipment, the resource set for the control region of the short TTI according to information carried in a legacy control region; or

obtaining, by the user equipment, the resource set for the control region of the short TTI as agreed on in advance with the network side.

Optionally the method further includes: detecting, by the user equipment, blindly the control channel of the user equipment in the set of resources for the control channel of the user equipment.

Correspondingly an embodiment of the invention provides a method for mapping to a resource at the base station side, the method including:

determining, by a base station, a resource set for a control region of a short Transmission Time Interval (TTI) of a user equipment; and

mapping, by the base station, a control channel of a short TTI of the user equipment to a set of resources within the resource set.

With this method, the base station determines the resource set for the control region of the short Transmission Time Interval (TTI) of the user equipment, and the base station maps the control channel of a short TTI of the user equipment to a set of resources within the resource set, so that in the case that the user equipment determines the resource set for a control region of a short TTI, the user equipment can determine the resources for a control channel of the user equipment in the resource set for a control region of a short TTI.

Optionally the resource set is a resource set agreed on in advance with the user equipment.

Optionally the method further includes: notifying, by the base station, the user equipment of the resource set.

In this way, the user equipment can determine the resource set for the control region of a short Transmission Time Interval (TTI), and further determine the resources for a control channel of the user equipment in the resource set.

Optionally notifying, by the base station, the user equipment of the resource set includes:

notifying, by the base station, the user equipment of the resource set for the control region of the short TTI of the user equipment through higher-layer signaling; or

notifying, by the base station, the user equipment of the resource set for the control region of the short TTI of the user equipment in a sub-frame through information carried in the legacy control region located in the same sub-frame.

Optionally when the base station notifies the user equipment of the resource set for a control region of a short TTI of the user equipment through the higher-layer signaling, it is notified via the higher-layer signaling that the resource set for control regions across all the short TTIs in a sub-frame is uniform; or a resource set for a control region of each short TTI in the sub-frame is notified via the higher-layer signaling separately.

Optionally when the base station notifies the user equipment of the resource set for a control region of a short TTI of the user equipment in a sub-frame through the information carried in the legacy control region in the same sub-frame, the resource set for control regions across all the short TTIs in the sub-frame is uniform and notified by the information; or the resource set for the control region of each short TTI in the sub-frame respectively through the information carried in the legacy control region in the same sub-frame.

Optionally the resource set for a control region of a short TTI includes N resource block groups or P resource blocks in the frequency domain in the short TTI, and each resource block group includes M resource blocks, wherein N, P, and M are positive integers.

Optionally the N resource block groups are consecutive or discrete, or the P resource blocks are consecutive or discrete.

In correspondence to the method above at the user equipment side, an embodiment of the invention provides a first apparatus for determining a channel resource, the apparatus including:

a first determining unit configured to determine a resource set for a control region of a short Transmission Time Interval (TTI); and

a second determining unit configured to determine a set of resources for a control channel of the user equipment in the resource set,

Optionally the first determining unit is configured:

to obtain the resource set for the control region of the short TTI through higher-layer signaling; or

to obtain the resource set for the control region of the short TTI according to information carried in a legacy control region; or

to obtain the resource set for the control region of the short TTI as agreed on in advance with the network side.

Optionally the second determining unit is further configured: to detect blindly the control channel of the user equipment in the set of resources for the control channel of the user equipment.

In correspondence to the method above at the base station side, an embodiment of the invention provides a first apparatus for mapping to a resource, the apparatus including:

a first unit configured to determine a resource set for a control region of a short Transmission Time Interval (TTI) of a user equipment; and

a second unit configured to map a control channel of a short TTI of the user equipment to a set of resources within the resource set.

Optionally the resource set is a resource set agreed on in advance with the user equipment.

Optionally the first unit is further configured to notify the user equipment of the resource set.

Optionally the first unit is configured:

to notify the user equipment of the resource set for the control region of the short TTI of the user equipment through higher-layer signaling; or

to notify the user equipment of the resource set for the control region of the short TTI of the user equipment in a sub-frame through information carried in the legacy control region located in the same sub-frame.

Optionally when the first unit is configured to notify the user equipment of the resource set for the control region of the short TTI of the user equipment through the higher-layer signaling, the first unit is configured to notify the same resource set for control regions of all the short TTIs in a sub-frame through the higher-layer signaling; or the first unit is configured to notify the resource set for the control region of each short. TTI in the sub-frame through the higher-layer signaling separately.

Optionally when the first unit configured to notify the user equipment of the resource set for the control region of the short TTI of the user equipment in a sub-frame using the information carried in the legacy control region in the same sub-frame, the resource set for control regions across all the short TTIs in the sub-frame is uniform and notified by the information; or the first unit is configured to notify the resource set for the control region of each short TTI in the sub-frame respectively through the information in the legacy control region in the same sub-frame.

Optionally the resource set for the control region of the short TTI includes N resource block groups or P resource blocks in the frequency domain in the short TTI, and each resource block group includes M resource blocks, wherein N, P, and M are positive integers.

Optionally the N resource block groups are consecutive or discrete, or the P resource blocks are consecutive or discrete.

In correspondence to the method above at the user equipment side, an embodiment of the invention provides a second apparatus for determining a channel resource at the user equipment side, the apparatus including:

a processor configured to read and execute program in a memory:

to determine a resource set for a control region of a short Transmission Time Interval (TTI); and to determine a set of resources for a control channel of the user equipment in the resource set; and

a transceiver configured to receive and transmit data under the control of the processor.

Optionally the processor is configured:

to obtain the resource set for a control region of a short TTI through the higher-layer signaling; or

to obtain the resource set for a control region of a short TTI according to information carried in the legacy control region; or

to obtain the resource set for a control region of a short TTI as agreed on in advance with the network side.

Optionally the processor is further configured:

to detect blindly the control channel of the user equipment in the set of resources for the control channel of the user equipment.

In correspondence to the method above at the base station side, an embodiment of the invention provides a second apparatus for mapping to a. resource, the apparatus including:

a processor configured to read and execute program in a memory:

to determine a resource set for a control region of a short Transmission Time interval (TTI) of a user equipment; and to map a control channel of the short TTI of the user equipment to a set of resources within the resource set; and

a transceiver configured to receive and transmit data under the control of the processor.

Optionally the resource set is a resource set agreed on in advance with the user equipment.

Optionally the processor is further configured:

to notify the user equipment of the resource set.

Optionally the processor is configured:

to notify the user equipment of the resource set for the control region of the short TTI of the user equipment through higher-layer signaling; or

to notify the user equipment of the resource set for the control region of the short TTI of the user equipment in a sub-frame through information carried in the legacy control region in the same sub-frame.

Optionally when the resource set for the control region of the short TTI of the user equipment is notified to the user equipment through the higher-layer signaling, the processor is configured to notify a same resource set for control regions of all short TTIs in a sub-frame through high-layer signaling; or the processor is configured to notify the resource set for the control region of each short TTI in a sub-frame through the higher-layer signaling separately.

Optionally when the processor configured to notify the user equipment of the resource set for the control region of the short TTI of the user equipment in the sub-frame through the information carried in the legacy control region in the same sub-frame, the resource set for control regions of all short TTIs in the sub-frame is uniform and notified by the information; or the processor is configured to notify the resource set for the control region of each short TTI in the sub-frame respectively through the information in the legacy control region in the same sub-frame.

Optionally the resource set for the control region of the short TTI includes N resource block groups or P resource blocks in the frequency domain in the short TTI. and each resource block group includes M resource blocks, wherein N, P, and M are positive integers.

Optionally the N resource block groups are consecutive or discrete, or the P resource blocks are consecutive or discrete.

### BRIEF DESCRIPTION OF THE DRAWINGS

In order to make the technical solutions according to the embodiments of the invention more apparent, the drawings to which reference is to be made in the description of the embodiments will be introduced below in brief, and apparently the drawings to be described below are only some embodiments of the invention, and based upon these drawings, other drawings can occur to those ordinarily skilled in the art without any inventive effort.

FIG. 1 is a schematic diagram of the Frame Structure Type 1 in the prior art;

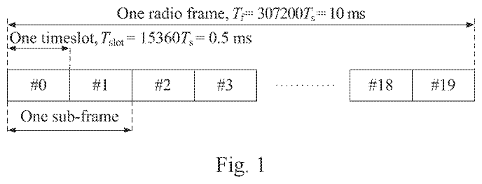

FIG. 2 is a schematic diagram of the Frame Structure Type 2 (for the 5 ms switch-point periodicity) in the prior art;

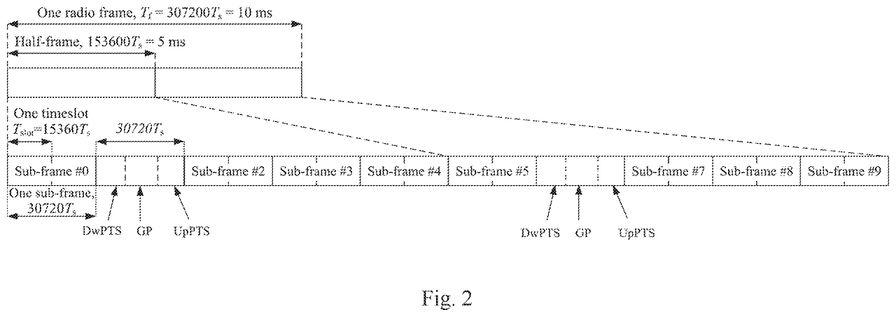

FIG. 3 is a schematic diagram of a downlink resource grid in the prior art;

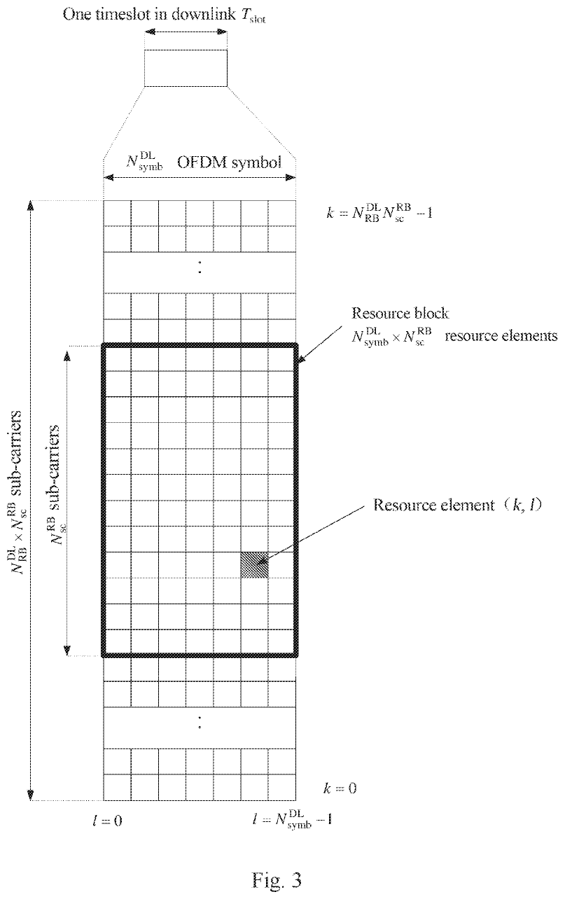

FIG. 4 is a schematic flow chart of a method for determining a channel resource according to an embodiment of the invention;

FIG. 5 is a schematic flow chart of a method for mapping to a resource according to an embodiment of the invention;

FIG. 6(a) and FIG. 6(b) are schematic diagrams of a method for determining a. transmission resource set for a control channel of a short TTI according to an embodiment of the invention;

FIG. 7(a), FIG. (b), and FIG. 7(c) are schematic diagrams of mapping a control channel of a short TTI to a set of resources in a control region according to an embodiment of the invention;

FIG. 8(a) and FIG. 8(b) are schematic diagrams of a method for determining a transmission resource set for a control channel of a short TTI according to an embodiment of the invention;

FIG. 9 is a schematic structural diagram of a first apparatus for determining a channel resource according to an embodiment of the invention;

FIG. 10 is a schematic structural diagram of a first apparatus for mapping to a resource according to an embodiment of the invention;

FIG. 11 is a schematic structural diagram of a second apparatus for determining a. channel resource according to an embodiment of the invention; and

FIG. 12 is a schematic structural diagram of a second apparatus for mapping to a. resource according to an embodiment of the invention.

### DETAILED DESCRIPTION

Embodiments of the invention provide a method and apparatus for determining a channel resource, and a method and apparatus for mapping to a resource, so that a user equipment can determine the resource for a control channel of the user equipment in a resource set for a control region of a short TTI.

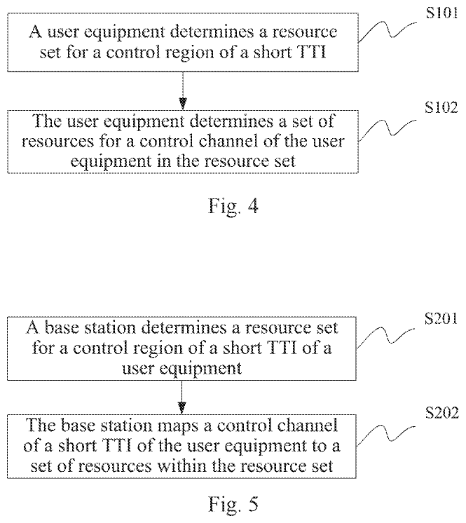

Referring to FIG. 4, a method for determining a channel resource at the user equipment side according to an embodiment of the invention includes the following steps.

In the step S101, a user equipment determines a resource set for a control region of a short Transmission Time Interval (TTI).

In the step S102, the user equipment determines a set of resources for a control channel of the user equipment in the resource set.

With this method, the user equipment determines the resource set for a control region of a short TTI, and determines a set of resources for a control channel of the user equipment in the resource set, so that the user equipment can determine the resources for a control channel of the user equipment in the resource set for the control region of the short

Here the resource set for the control region of the short III in the embodiment of the invention is also referred to as a bandwidth of a control region of a short TTI.

Optionally the user equipment determines the resource set for a control region of a. short TTI particularly as follows.

The user equipment obtains the resource set for a control region of a short TTI through higher-layer signaling; or the user equipment obtains the resource set for a control region of a short TTI according to information carried in a legacy control region; or the user equipment obtains the resource set for a control region of a short TTI as agreed on in advance with the network side.

Optionally the user equipment detects blindly the control channel of the user ilk equipment in the set of resources for a control channel of the user equipment.

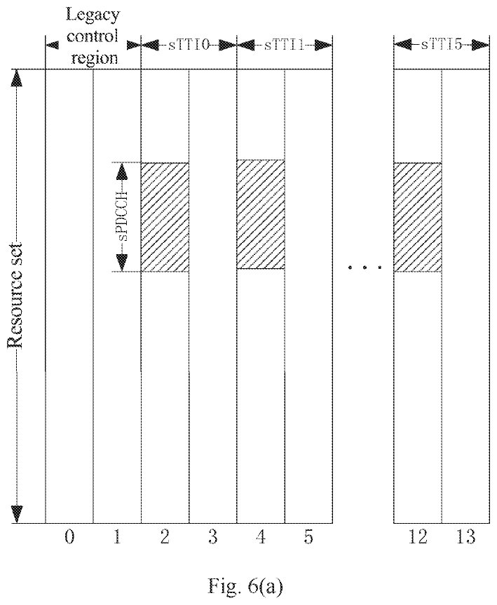

Correspondingly referring to FIG. 5. a method for mapping to a resource according to an embodiment of the invention includes the following steps.

In the step S201, a base station determines a resource set for a control region of a short Transmission Time interval (TTI) of a user equipment.

In the step S202, the base station maps a control channel of a short TTI of the user equipment to a set of resources within the resource set.

With this method, the base station determines the resource set for a control region of a. short Transmission Time Interval (TTI) of a user equipment, and the base station maps a control channel of a short TTI of the user equipment to resources within the resource set, so that in the case that the user equipment determines the resource set for a control region of a short TTI, the user equipment can determine the resources for a control channel of the user equipment in the resource set for a control region of a short TTI.

Optionally the base station notifies the user equipment of the resource set so that the user equipment can determine the resource set for a control region of a short Transmission Time Interval (TTI), and further determine the set of resources for a control channel of the user equipment in the resource set.

Optionally the base station notifies the user equipment of the resource set particularly as follows.

The base station notifies the user equipment of the resource set for a control region of a short TTI of the user equipment through higher-layer signaling; or the base station notifies the user equipment of the resource set for a control region of a short TTI of the user equipment in a sub-frame through information carried in the legacy control region in the same sub-frame.

Optionally when the base station notifies the user equipment of the resource set for a control region of a short TTI of the user equipment through the higher-layer signaling, it is notified through the higher-layer signaling that control regions of all the short TTIs in a sub-frame lie in the same resource set; or the resource set for a control region of each short TTI in a sub-frame is notified through the higher-layer signaling separately.

Optionally when the base station notifies the user equipment of the resource set for a control region of a short TTI of the user equipment in the sub-frame through the information carried in the legacy control region in the same sub-frame, the resource set for control regions across all short TTIs in the sub-frame is uniform and notified by the information; or the resource set for control region of each short TTI in the sub-frame is notified respectively through the information in the legacy control region in the same sub-frame.

Stated otherwise, the base station carries the information about the resource set(s) for the control regions in the short TTIs in the sub-frame, in the legacy control region.

The information is sub-frame-common, that is, the resource set for the control regions across all short TTIs in the sub-frame is uniform and notified by the information,

Or, the information is sTTI-specific, that is, the base station notifies the resource set for the control regions of each short TTI in the sub-frame respectively using some number of bits in the legacy control region.

Optionally the resource set for a control region of a short TTI includes N Resource Block (RB) groups or P Resource Blocks (RBs) in the frequency domain in the short TTI and each resource block group includes M resource blocks, where N, P, and M are positive integers.

Optionally the N resource block groups are consecutive or discrete, or the P resource blocks are consecutive or discrete.

Stated otherwise, the N RB groups or the P RBs can be N consecutive RB groups or P consecutive RBs, or can be N discrete RB groups or P discrete RBs.

Several specific embodiments will be described below.

### First Embodiment

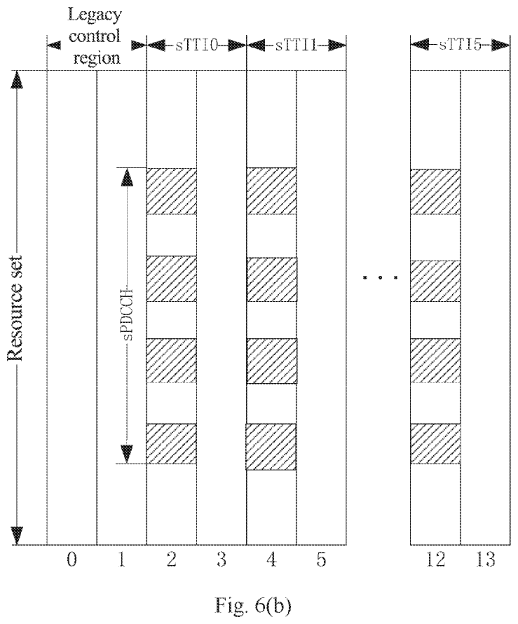

In this embodiment, for example, the length of a short TTI in the time domain is two OFDM symbols, and a legacy control region in an LTE system occupies two OFDM symbols, so there are six short TTIs in a sub-frame, which are sTTI0, sTTI1, sTTI3, sTTI4, and sTTI5 respectively, where an sTT1 represents a short TT1. For example, a control region of each short TTI is located in the first OFDM symbol. The same resource set is used for control regions of all the short ITTs in a sub-frame, and a base station notifies a UE of the resource set for the control regions of all short TTIs in the sub-frame through higher-layer signaling, and for example, it is indicated through the higher-layering signaling that a control region of a short TTI is N RBs in a system resource set, where N is a positive integer more than or equal to 1. Here the N RBs can be N consecutive RBs as illustrated in FIG. 6(a), or the N RBs can be N discrete RBs as illustrated in FIG. 6(b).

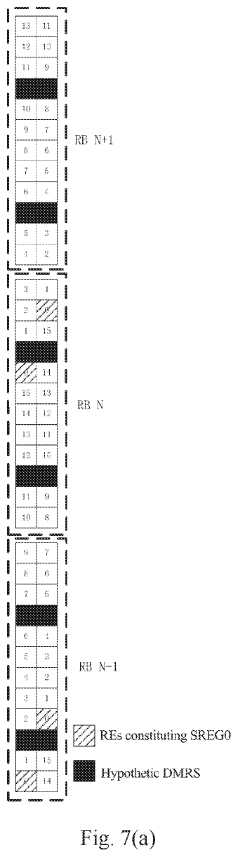

The base station determines available resources in an allocated sPDCCH (i.e., PDCCH corresponding to a short TTI) resource set, and maps control information for scheduling data. transmission in the short TTI onto specific resource(s) in the sPDCCH resource set. For example, there are three RBs in a downlink control region of the short III, so a control channel of a short TTI can be mapped to a set of resources in the downlink control region as illustrated in FIG. 7(a). FIG. 7(b), and FIG. 7(c). As illustrated in FIG. 7(b), for example, bit information to be carried in the sPDCCHs is concatenated, scrambled, modulated, layer-mapped, and pre-coded into information synibols, the information symbols are divided into quadruples, and the quadruples are interleaved. The interleaved quadruples are mapped onto the resources in the control region of the short TTI. For example, there is only one sCCE (the CCE corresponding to the short TTI) in the control region, and the sCCE includes nine sREGs, so the sREGs in the sCCE can be mapped in the control region in the short TTI as illustrated in FIG. 7(b). Or the sPDCCHs can be mapped in the resource set in the control region in the same way as EPDCCHs, and in this way, the sCCE includes a plurality of sREGs as illustrated in FIG. 7(a). Or the resource is mapped in the unit of RB, downlink control information is mapped to the RBs occupied by the control channel in a firstly frequency-domain and then time-domain or firstly time-domain and then frequency-domain (only frequency-domain when the control region of the short TTI occupies only one OFDM) order as illustrated in FIG. 7(a) and FIG. 7(c). The UE detects blindly its sPDCCH in a search space allocated for the UE in the resource set for the control region. The UE obtains its scheduling information as a result of de-interleaving, demodulation, and other operations upon reception of the sPDCCH of the UE using a Radio Network Temporary Identifier (INTI).

Furthermore FIG. 6(a) and FIG. 6(b) illustrate a possible position example that the resource set for the control region of the short TTI is located in the frequency domain in the short TTI, but the control region can alternatively be located in other position in the frequency domain in the short TTI, or can occupy more than one OFDM symbol. The resource set for the control region of the short TTI may alternatively be notified through the higher-layer signaling as per RB group.

### Second Embodiment

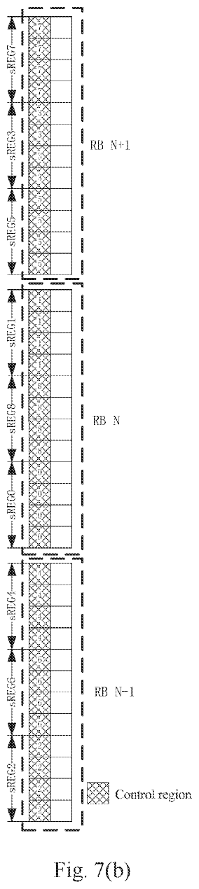

In this embodiment, for example, the length of a short TTI in the time domain is two OFDM symbols, and a legacy control region in an LTE system occupies two OFDM symbols, so there are six short TTIs in a sub-frame, which are sTTI0, sTTI1, sTTI2, sTTI3, sTTI4, and sTTI5 respectively. For example, a control region of each short TTI is located in the first OFDM symbol. Information about resource set for control region of each short TTI in the sub-frame is configured separately via higher-layer signaling, and the position, in the frequency domain, of the control region of each short TTI in a resource set for the short TTIs may or may not be the same. For example, the high-layer signaling indicates N RBs, in a system resource set, occupied by a control region of each short TTI, where N is a positive integer more than or equal to 1. Here the N RBs can be N consecutive RBs as illustrated in FIG. 8(a), or the N RBs can be N discrete RBs as illustrated in FIG. 8(b); and the positions, in the frequency domain, of the control regions of the respective short. TTIs, in the resource set for the short TTIs may or may not be the same as illustrated in FIG. 8(a) and FIG. 8(b).

The base station determines available resources in an allocated sPDCCH set, and maps control information for scheduling data transmission in the short TTI onto specific resource(s) in the sPDCCH resource set. For example, there are three RBs in a downlink control region of the short fri. so a control channel of a short TTI can be mapped to a set of resources in the downlink control region as illustrated in FIG. 7(a), FIG. 7(b), and FIG. 7(c). As illustrated in FIG. 7(b), for example, bit information to be carried in the sPDCCFIs is concatenated, scrambled, modulated, layer-mapped, and pre-coded into information symbols, the information symbols are divided into quadruples, and the quadruples are interleaved. The interleaved quadruples are mapped onto the resources in the control region of the short TTI. For example, there is only one sCCE in the control region, and the sCCE includes 9 sREGs, so the sREGs in the sCCE can be mapped in the control region of the short TTI as illustrated in FIG. 7(b) or the sPDCCHs can be mapped in the resource set in the control region in the same way as EPDCCHs, and in this way, the sCCE includes a plurality of sREGs as illustrated in FIG. 7(a); or the resource is mapped in the unit of RB, downlink control information is mapped to the RBs occupied by the control channel in a firstly frequency-domain and then time-domain or firstly time-domain and then frequency-domain (only frequency-domain when the control region of the short TTI occupies only one OFDM) order as illustrated in FIG. 7(a) and FIG. 7(c). The UE detects blindly its sPDCCH in a search space allocated for the UE in the resource set for the control region. The UE obtains its scheduling information as a result of de-interleaving, demodulation, and other operations upon reception of the sPDCCH of the UE using an RNTI.

Furthermore FIG. 6(a) and FIG. 6(b) illustrate a possible position example that the resource set for the control region of the short TTI is located in the frequency domain in the short TTI, but the control region can alternatively be located in other position in the frequency domain, or can occupy more than one OFDM symbol. The resource set for the control region of the short TTI may alternatively be notified via the higher-layer signaling as per RB group.

### Third Embodiment

In this embodiment, for example, the length of a short TTI in the time domain is two or seven OFDM symbols, and a legacy control region in an LTE system occupies two OFDM symbols. For example, in each short TTI, a control region of a short TTI with the length of two OFDM symbols is located in the first OFDM symbol, and a control region of a short TTI with the length of seven OFDM symbols is located in the first and second OFDM symbols, When frequency resource, in a resource set for the short TTI, occupied by the control region of each short TTI are notified through higher-layer signaling, the resource set for the control region of the short TTI is allocated according to the time length of the short TTI. For example, when the frequency resource is notified via the higher-layer signaling, the control region of the short ITT with the length of two OFDM symbols in a sub-frame occupies the first M RBs in the frequency domain in the short TTI, and a control region of a short TTI with the length of seven OFDM symbols in a sub-frame occupies the first N RBs in the frequency domain in the short TTI, where both M and N are positive integers more than or equal to 1.

The base station determines available resources in an allocated sPDCCH resource set, and maps control information for scheduling data transmission in the short TTI onto a specific resource in the sPDCCH resource set. For example, there are three RBs in a downlink control region in the short TTI, so a control channel of a short TTI can be mapped to a resource in the downlink control region as illustrated in FIG. 7(a), FIG. 7(b), and FIG. 7(c). As illustrated in FIG. 7(b), for example, bit information to be carried in the sPDCCHs is concatenated, scrambled, modulated, layer-mapped, and pre-coded into information symbols, the information symbols are divided into quadruples, and the quadruples are interleaved. The interleaved quadruples are mapped onto the resources in the control region of the short TTI. For example, there is only one sCCE in the control region, and the sCCE includes nine sREGs, so the sREGs in the sCCE can be mapped in the control region in the short TTI as illustrated in FIG. 7(b); or the sPDCCHs can be mapped in the resource set in the control region in the same way as EPDCCHs, and in this way, the sCCE includes a plurality of sREGs as illustrated in FIG. 7(a): or the resource is mapped in the unit of RB, downlink control information is mapped to the RBs occupied by the control channel in a firstly frequency-domain and then time-domain or firstly time-domain and then frequency-domain (only frequency-domain when the control region of the short TTI occupies only one OFDM) order as illustrated in FIG. 7(a) and FIG. 7(c). The UE detects blindly its sPDCCH in a search space allocated for the UE in the resource set for the control region. The UE obtains its scheduling information as a result of de-interleaving, demodulation, and other operations upon reception of the sPDCCH of the UE using an RNTI.

Furthermore this embodiment illustrates a possible position example that the resource set for the control region of the short TTI is located in the frequency domain in the short TTI, but the control region of short TTI can alternatively be located in other position in the frequency domain in the short TTI or can occupy other number OFDM symbols. The resource set for the control region of the short TTI may alternatively be notified via the higher-layer signaling as per RB group.

### Fourth Embodiment

in this embodiment, for example, the length of a short TTI in the time domain is two OFDM symbols, and a legacy control region in an LTE system occupies two OFDM symbols, so there are six short TTIs in a sub-frame, which are sTTI0, sTTI1, sTTI2, sTTI3, sTTI4, and sTTI5 respectively. For example, a control region of each short Iii is located in the first OFDM symbol. A base station carries some number of information bits in a common search space of the legacy control region in the LTE system to indicate the position, occupied by the control regions of all the short TTIs in the sub-frame, in the frequency domain in the short TTIs. For example, RBs, occupied by the control regions of the short TTIs in the sub-frame, in the frequency domain in the short TTIs are indicated. In this embodiment, the information is sub-frame-specific, that is, frequency information of the control channels of all short TTIs in the sub-frame is notified via the information as illustrated in FIG. 6(a) and FIG. 6(b).

The base station determines available resources in an allocated sPDCCH resource set, and maps control information for scheduling data transmission in the short TTI onto a specific resource in the sPDCCH resource set. For example, there are three RBs in a downlink control region of the short so a control channel of a short TTI can be mapped to a resource in the downlink control region as illustrated in FIG. 7(a), FIG. 7(b), and FIG. 7(c). As illustrated in FIG. 7(b), for example, bit information to be carried in the sPDCCFIs is concatenated, scrambled, modulated, layer-mapped, and pre-coded into information symbols, the information symbols are divided into quadruples, and the quadruples are interleaved. The interleaved quadruples are mapped onto the resources in the control region of the short TTI. For example, there is only one sCCE in the control region, and the sCCE includes 9 sREGs, so the sREGs in the sCCE can be mapped in the control region of the short TTI as illustrated in FIG. 7(b) or the sPDCCHs can be mapped in the resource set in the control region in the same way as EPDCCHs, and in this way, the sCCE includes a plurality of sREGs as illustrated in FIG. 7(a); or the resource s mapped in the unit of RB, the downlink control information is mapped to the RBs occupied by the control channel in a firstly frequency-domain and then time-domain or firstly time-domain and then frequency-domain (only frequency-domain when the control region of the short TTI occupies only one OFDM) order as illustrated in FIG. 7(a) and FIG. 7(c). The UE detects blindly its sPDCCH in a search space allocated for the UE in the resource set for the control region. The UE obtains its scheduling information as a result of de-interleaving, demodulation, and other operations upon reception of the sPDCCH of the UE using an RNTI. Furthermore FIG. 6 illustrates a possible position example that the resource set for the control region of the short TTI is located in the frequency domain in the short TTI, but the control region of the short TTI can alternatively be located in other position in the frequency domain in the short TTI, or can occupy more than one OFDM symbol. The resource set for the control region of the short TTI may alternatively be notified via the higher-layer signaling as per RB group.

### Fifth Embodiment

In this embodiment, for example, the length of a short TTI in the time domain is two OFDM symbols, and a legacy control region in an LTE system occupies two OFDM symbols, so there are six short TTIs in a sub-frame, which are sTTI0, sTTI1, sTTI2, sTTI3, sTTI4, and sTTI5 respectively. For example, a control region of each short TTI is located in the first OFDM symbol. A base station carries some number of information bits in a common search space of the legacy control region in the LTE system to indicate the positions, occupied by the control regions of all the short TTIs in the sub-frame, in a resource set for the short TTIs. For example, RBs, occupied by the control regions of the short. TTIs in the sub-frame, in the frequency domain in the short TTIs are indicated, In this embodiment, the information is sub-frame-specific, that is, frequency information of the control channel of each short TTI in the sub-frame is notified via the information. The positions of the frequency resources, occupied by the control regions in the different short TTIs, may or may not be the same as illustrated in FIG. 7(a), FIG. 7(b), and FIG. 7(c).

The base station determines available resources in an allocated sPDCCH resource set, and maps control information for scheduling data transmission in the short TTI onto a specific resource in the sPDCCH resource set. For example. there are three RBs in a downlink control region of the short TTI, so a control channel of a short TTI can he mapped to a resource in the downlink control region as illustrated in FIG. 7(a), FIG. 7(b), and FIG. 7(c). As illustrated in FIG. 7(b), for example, bit information to be carried in the sPDCCHs is concatenated, scrambled. modulated, layer-mapped, and pre-coded into information symbols, the information symbols are divided into quadruples, and the quadruples are interleaved. The interleaved quadruples are mapped onto the resources in the control region of the short TTI. For example, there is only one sCCE in the control region, and the sCCE includes 9 sREGs, so the sREGs in the sCCE can be mapped in the control region of the short TTI as illustrated in FIG. 7(b); or the sPDCCHs can be mapped in the resource set in the control region in the same way as EPDCCHs, and in this way, the sCCE includes a plurality of sREGs as illustrated in FIG. 7(a); or the resource is mapped in the unit of RB, the downlink control information is snapped to the RBs occupied by the control channel in a firstly frequency-domain and then time-domain or firstly time-domain and then frequency-domain (only frequency-domain when the control region of the short TTI occupies only one OFDM) order as illustrated in FIG. 7(a) and. FIG. 7(c). The UE detects blindly its sPDCCH in a search space allocated for the UE in the resource set for the control region. The UE obtains its scheduling information as a result of de-interleaving, demodulation, and other operations upon reception of the sPDCCH of the UE using an RNTI. Furthermore FIG. 6(a) and FIG. 6(b) illustrate a possible position example that the resource set for the control region of the short TTI is located in the frequency domain in the short TTI, but the control region of the short TTI can alternatively be located in other position in the frequency domain in the short TTI, or can occupy more than one OFDM symbol. The resource set for the control region of the short TTI may alternatively be notified via the higher-layer signaling as per RB group.

### Sixth Embodiment

In this embodiment, frequency resources occupied by a control region of a short TTI are distributed at fixed positions in the frequency domain in the short TTI in a predefined manner, and these positions may he consecutive or may be discrete, and will not be indicated explicitly. For example, the length of a short TTI in the time domain is two OFDM symbols, and a legacy control region in an LTE system occupies two OFDM symbols, so there are six short TTIs in a sub-frame, which are sTTI0, sTTI1, sTTI2, sTTI3, sTTI4, and sTTI5 respectively. For example, a control region of each short TTI is located in the first OFDM symbol. FIG. 6(a) and FIG. 6(b), and FIG. 8(a) and FIG. 8(b) illustrate schematic diagrams of frequency positions, occupied by the control regions of the short TTIs. A control channel of a. short TTI can be mapped to a resource in a resource set for the control regions in the short TTIs as described in the first to fifth embodiments, so a repeated description thereof will be omitted here.

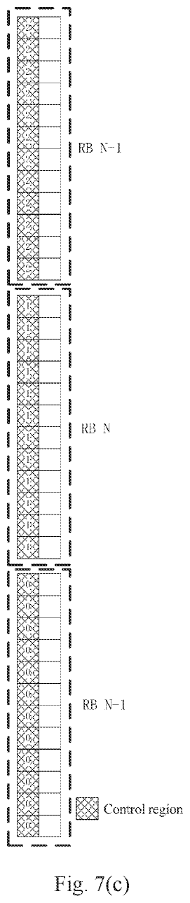

Referring to FIG. 9, a first apparatus for determining a channel resource at the user equipment side according to an embodiment of the invention includes the following units.

A first determining unit 11 is configured to determine a resource set for a control region of a short Transmission Time Interval (TTI).

A second determining unit 12 is configured to determine a set of resources for a control channel of the user equipment in the resource set.

Optionally the first determining unit is configured: to obtain the resource set for the control region of the short TTI through higher-layer signaling; or to obtain the resource set for the control region of the short TTI according to information carried in a legacy control region; or to obtain the resource set for the control region of the short TTI as agreed on in advance with the network side.

Optionally the second determining unit is further configured: to detect blindly the control channel of the user equipment in the set of resources for the control channel of the user equipment.

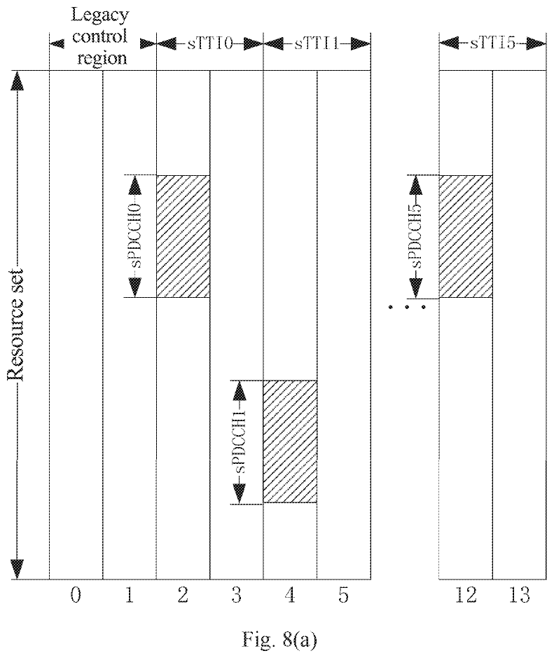

Referring to FIG. 10, a first apparatus for mapping to a resource at the base station side according to an embodiment of the invention includes the following units.

A first unit 21 is configured to determine a resource set for a control region of a short Transmission Time Interval (TTI) of a user equipment.

A second unit 22 is configured to map a control channel of the short TTI of the user equipment to a set of resources within the resource set.

Optionally the resource set is a resource set agreed on in advance with the user equipment.

Optionally the first unit is further configured to notify the user equipment of the resource set.

Optionally the first unit is configured: to notify the user equipment of the resource set for the control region of the short TTI of the user equipment through higher-layer signaling; or, notify the user equipment of the resource set for the control region of the short TTI of the user equipment in a sub-frame through information carried in the legacy control region in the same sub-frame.

Optionally when the resource set for the control region of the short TTI of the user equipment is notified to the user equipment through the higher-layer signaling, the first unit is configured to notify the same resource set for control regions of all short transmission time intervals in a sub-frame through the higher-layer signaling; or the first unit is configured to notify the resource set for the control region of each short TTI in the sub-frame through the higher-layer signaling separately.

Optionally when the first unit is configured to notify the user equipment of the resource set for the control region of the short TTI of the user equipment in a sub-frame through the information carried in the legacy control region in the same sub-frame, the resource set for control regions across all the short TTIs in the sub-frame is uniform and notified by the information; or the first unit is configured to notify the resource set for the control region of each short TTI in the sub-frame respectively through the information in the legacy control region in the same sub-frame.

Optionally the resource set for the control region of the short TTI includes N resource block groups or P resource blocks in the frequency domain in the short TTI, and each resource block group includes M resource blocks, where N, P, and M are positive integers.

Optionally the N resource block groups are consecutive or discrete, or the P resource blocks are consecutive or discrete.

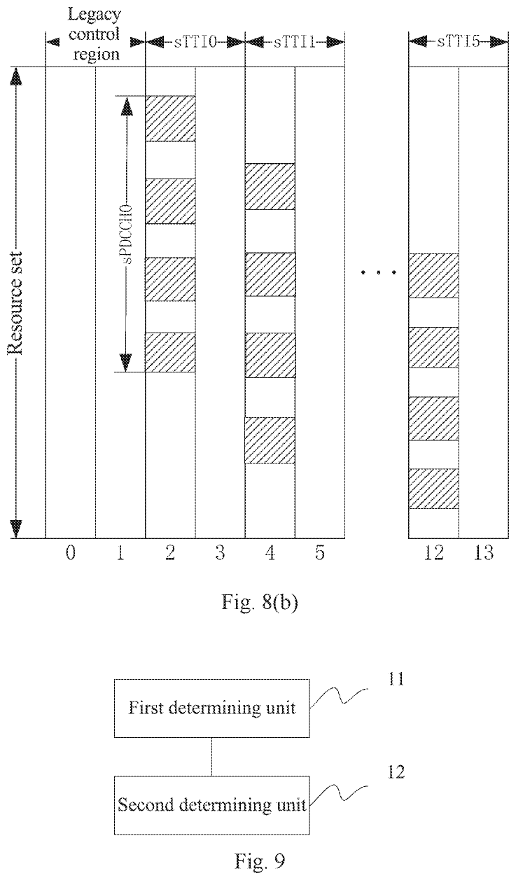

Referring to FIG. 11, a second apparatus for determining a channel resource at the UE side according to an embodiment of the invention includes the followings.

A processor 600 is configured to read and execute program in a memory 620: to determine a resource set for a control region in a short Transmission Time Interval (TTI); and to determine a set of resources for a control channel of the user equipment in the resource set.

A transceiver 610 is configured to receive and transmit data wider the control of the processor 600.

Optionally the processor 600 is configured: to receive high-layer signaling through the transceiver 610, and to obtain the resource set for the control region of the short TTI through the higher-layer signaling; or to receive a legacy control region through the transceiver 610, and to obtain the resource set for the control region of the short TTI according to information carried in ilk the legacy control region; or to obtain the resource set for the control region of the short TTI as agreed on in advance with the network side.

Optionally the processor 600 is further configured: to detect blindly the control channel of the user equipment in the set of resources for the control channel of the user equipment.

The transceiver 610 is configured to receive and transmit data under the control of the processor 600.

Here in FIG. 11, the bus architecture can include any number of interconnecting buses and bridges to particularly link together various circuits including one or more processors represented by the processor 600, and one or more memories represented by the memory 620. The bus architecture can further link together various other circuits, e.g., a peripheral device, a manostat, a power management circuit, etc., all of which are well known in the art, so a further description thereof will be omitted in this context. The bus interface serves as an interface. The transceiver 610 can be a number of elements, e.g., a transmitter and a receiver, which are units for communication with various other devices over a transmission medium. For different user equipments, the user interface 630 can also be an interface via which devices are connected internally and externally as needed, and the connected devices include but will not be limited to a keypad, a display, a speaker, a microphone, a joystick, etc.

The processor 600 is responsible for managing the bus architecture and performing normal processes, and the memory 620 can store data for use by the processor 600 in performing the operations.

Optionally the processor 600 can be a Central Processing Unit (CPU), an Application Specific Integrated Circuit (ASIC), a Field Programmable Gate Array (FPGA), or a Complex Programmable Logic Device (CPLD).

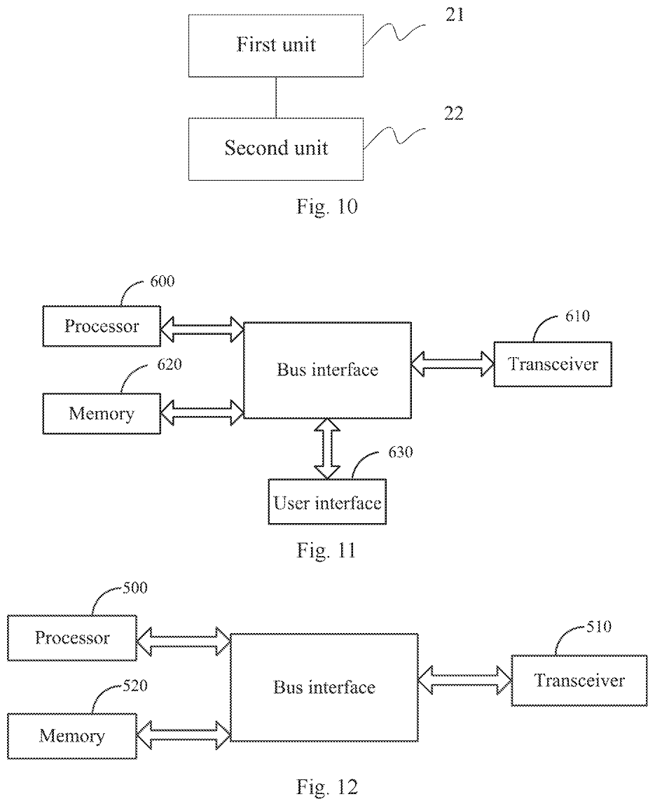

Referring to FIG. 12, a second apparatus for mapping to a resource at the base station side according to an embodiment of the invention includes the followings.

A processor 500 is configured to read and execute program in a memory 520: to determine a resource set for a control region of a short Transmission Time Interval (TTI) of a user equipment; and to map a control channel of the short TTI of the user equipment to a set of resources within the resource set.

The transceiver 510 is configured to receive and transmit data under the control of the processor 500.

Optionally the resource set is a resource set agreed on in advance with the user equipment.

Optionally the processor 500 is further configured to notify the user equipment of the resource set through the transceiver 510.

Optionally the processor 500 is configured: to control the transceiver 510 to notify the user equipment of the resource set for the control region of the short TTI of the user equipment through higher-layer signaling; or to control the transceiver 510 to notify the user equipment of the resource set for the control region of the short TTI of the user equipment in a sub-frame through information carried in the legacy control region in the same sub-frame.

Optionally when the processor 500 configured to control the transceiver 510 to notify the user equipment of the resource set for the control region of the short TTI of the user equipment through the higher-layer signaling, the processor is configured to notify the same resource set for control regions of all the short TTIs in a sub-frame through the high-layer signaling; or the processor is configured to notify the resource set for the control region of each short TTI in a sub-frame through the higher-layer signaling separately.

Optionally when the processor 500 is configured to control the transceiver 510 to notify the user equipment of the resource set for the control region of the short TTI of the user equipment in a sub-frame through the information carried in the legacy control region in the same sub-frame, the resource set for control regions across all the short TTIs in the sub-frame is uniform and notified by the information; or to notify the resource set for control region of each short TTI in the sub-frame respectively through the information in the legacy control region in the same-subframe.

Optionally the resource set for a control region in a short TTI includes N resource block groups or P resource blocks in the frequency domain in the short TTI, and each resource block group includes M resource blocks, where N, P, and M are positive integers.

Optionally the N resource block groups are consecutive or discrete, or the P resource blocks are consecutive or discrete.

Here in FIG. 12, the bus architecture can include any number of interconnecting buses and bridges to particularly link together various circuits including one or more processors represented by the processor 500, and one or more memories represented by the memory 520. The bus architecture can further link together various other circuits, e.g., a peripheral device, a manostat, a power management circuit, etc., all of which are well known in the art, so a further description thereof will be omitted in this context. The bus interface serves as an interface. The transceiver 510 can be a number of elements, e.g., a transmitter and a receiver, which are units for communication with various other devices over a transmission medium. The processor 500 is responsible for managing the bus architecture and performing normal processes, and the memory 520 can store data for use by the processor 500 in performing the operations.

The processor 500 can be a CPU, an ASIC, an FPGA, or a CPLD.

In summary, in the embodiments of the invention, the UE is notified of frequency resources occupied by a control region of a short TTI of the UE via higher-layer signaling, the UE is notified of frequency resources occupied by a control region of a short TTI of the UE by information bits transmitted in a legacy control region, or a control region of a short TTI is distributed over fixed frequency resources, and determined in a predefined manner, so that the user equipment can determine the resource set for a control region of a short TTI, determine the the resource position for a control channel of the user equipment in the resource set, and subsequently detects the control channel of the user equipment in the resource position for the control channel of the user equipment in the resource set.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, an optical memory, etc.) in which computer useable program codes are contained,

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for determining a channel resource, comprising:
determining, by a user equipment, a resource set for a control region of a short transmission time interval; and
determining, by the user equipment, a set of resources for a control channel of the user equipment in the resource set.

2. The method according to claim 1, wherein determining, by the user equipment, the resource set for the control region of the short transmission time interval comprises:
obtaining, by the user equipment, the resource set for the control region of the short transmission time interval through higher-layer signaling; or
obtaining, by the user equipment, the resource set for the control region of the short transmission time interval according to information carried by a PDCCH transmitted in a legacy control region; or
obtaining, by the user equipment, the resource set for the control region of the short transmission time interval as agreed on in advance with a network side.

3. The method according to claim 1, further comprises:
detecting, by the user equipment, blindly the control channel of the user equipment in the set of resources for the control channel of the user equipment.

4. A method for mapping to a resource, comprising:
determining, by a base station, a resource set for a control region of a short transmission time interval of a user equipment; and
mapping, by the base station, a control channel of the short transmission time interval of the user equipment to a set of resources within the resource set.

5. The method according to claim 4, wherein the resource set is a resource set agreed on in advance with the user equipment.

6. The method according to claim 4, further comprises: notifying, by the base station, the user equipment of the resource set.

7. The method according to claim 6, wherein notifying, by the base station, the user equipment of the resource set comprises:
notifying, by the base station, the user equipment of the resource set for the control region of the short transmission time interval of the user equipment through higher-layer signaling; or
notifying, by the base station, the user equipment of the resource set for the control region of the short transmission time interval of the user equipment in a sub-frame through information carried by PDCCH transmitted in the legacy control region located in the same sub-frame.

8. The method according to claim 7, wherein when the base station notifies the user equipment of the resource set for the control region of the short transmission time interval of the user equipment through the higher-layer signaling, a same resource set for control regions of all the short transmission time intervals in a sub-frame is notified through the higher-layer signaling; or the resource set for the control region of each short transmission time interval in the sub-frame is notified through the higher-layer signaling separately.

9. The method according to claim 7, wherein when the base station notifies the user equipment of the resource set for the control region of the short transmission time interval in a sub-frame through the information carried by PDCCH transmitted in the legacy control region in the same sub-frame, the resource set for control regions across all short transmission time intervals in the sub-frame is uniform and notified by the information; or the resource set for the control region of each short transmission time interval in the sub-frame is notified respectively through the information carried by PDCCH transmitted in the legacy control region in the same sub-frame.

10. The method according to claim 4, wherein the resource set for the control region of the short transmission time interval comprises N resource block groups or P resource blocks in a frequency domain in the short transmission time interval, the N resource block groups are consecutive or discrete in frequency domain, or the P resource blocks are consecutive or discrete in frequency domain, and each resource block group comprises M resource blocks, wherein N, P, and M are positive integers.

11.-22. (canceled)

23. An apparatus for determining a channel resource, comprising:
a processor configured to read and execute program in a memory:
to determine a resource set for a control region of a short transmission time interval; and to determine a set of resources for a control channel of the user equipment in the resource set; and
a transceiver configured to receive and transmit data under a control of the processor.

24. The apparatus according to claim 23, wherein the processor is configured:
to obtain the resource set for the control region of the short transmission time interval through the higher-layer signaling; or
to obtain the resource set for the control region of the short transmission time interval according to information carried by a PDCCH transmitted in the legacy control region; or
to obtain the resource set for the control region of the short transmission time interval as agreed on in advance with a network side.

25. The apparatus according to claim 23, wherein the processor is further configured:
to detect blindly the control channel of the user equipment in the set of resources for the control channel of the user equipment.

26. An apparatus for mapping to a resource, the apparatus comprising:
a processor configured to read and execute program in a memory:
to determine a resource set for a control region of a short transmission time interval of a user equipment; and to map a control channel of the short transmission time interval of the user equipment to a set of resources within the resource set; and
a transceiver configured to receive and transmit data under a control of the processor.

27. The apparatus according to claim 26, wherein the resource set is a resource set agreed on in advance with the user equipment.

28. The apparatus according to claim 26, wherein the processor is further configured:
to notify the user equipment of the resource set.

29. The apparatus according to claim 28, wherein the processor is configured:
to notify the user equipment of the resource set for the control region of the short transmission time interval of the user equipment through higher-layer signaling; or
to notify the user equipment of the resource set for the control region of the short transmission time interval of the user equipment in a sub-frame through information carried by PDCCH transmitted in the legacy control region located in the same sub-frame.

30. The apparatus according to claim 29, wherein when the resource set for the control region of the short transmission time interval of the user equipment is notified to the user equipment through the higher-layer signaling, the processor is configured to notify a same resource set for control regions of all short transmission time intervals in a sub-frame through high-layer signaling; or the processor is configured to notify the resource set for the control region of each short transmission time interval in the sub-frame through the higher-layer signaling separately.

31. The apparatus according to claim 29, wherein when the processor configured to notify the user equipment of the resource set for the control region of the short transmission time interval of the user equipment in a sub-frame through the information carried by PDCCH transmitted in the legacy control region in the same sub-frame, the resource set for control regions across all short transmission time intervals in the sub-frame is uniform and notified by the information; or the processor is configured to notify the resource set for the control region of each short transmission time interval in the sub-frame respectively through the information carried by PDCCH transmitted in the legacy control region in the same sub-frame.

32. The apparatus according to claim 26, wherein the resource set for the control region of the short transmission time interval comprises N resource block groups or P resource blocks in a frequency domain in the short transmission time interval, the N resource block groups are consecutive or discrete in the frequency domain, or the P resource blocks are consecutive or discrete in the frequency domain, and each resource block group comprises M resource blocks, wherein N, P, and M are positive integers.

33. (canceled)
